(19) United States
(12) Patent Application Publication
(10) Pub. No.: US 2025/0002387 A1
(43) Pub. Date: Jan. 2, 2025

(54) METHOD FOR MANUFACTURING GLASS

(71) Applicant: ARC FRANCE, Arques (FR)

(72) Inventors: Xavier IBLED, Arques (FR); Hervé CHARLES, Arques (FR)

(73) Assignee: ARC FRANCE, Arques (FR)

(21) Appl. No.: 18/573,579

(22) PCT Filed: Jun. 23, 2022
(86) PCT No.: PCT/FR2022/051239

§ 371 Date: Jun. 10, 2024

(30) Foreign Application Priority Data
Jul. 9, 2021 (FR) FR2107458

(51) Int. Cl. C03B 1/00; C03B 5/02

(52) U.S. Cl. CPC C03B 1/00; C03B 5/02

(57) ABSTRACT

Method for manufacturing glass, comprising preparing a mixture of glass raw materials for a glassworks furnace, wherein water, sand and sodium carbonate are mixed in mass proportions of between 0 and 5%, 40 and 65%, and more than 0 and no more than 25% respectively, and, within a time of less than 10 minutes, preferably simultaneously, calcium oxide is added in a mass proportion of between 1 and 20% of the total, the calcium oxide has a granulometry such that more than 97% by mass does not pass through a sieve of 0.125 mm, more than 96% by mass does not pass through a sieve of 0.5 mm, preferably more than 95% by mass does not pass through a sieve of 1 mm.

The invention relates to the field of the glass-making industry. Melting the materials forming the glass requires the provision of a large quantity of energy. The temperature of the glass bath is of the order of 1300 to 1500° C. Depending on its composition, the glass is intended for direct household use, for example drinking glasses, or glazing, or indirect, for example vitroceramic plates, or industrial.

The furnace is subjected to very high thermal and mechanical stresses. The furnace is constructed with high-quality refractory linings. These refractory linings are expensive and sensitive to certain constituents of the glass capable of chemical reaction. Since the refractory linings are poor conductors of heat, the glass bath is heated from above.

A liquid or gaseous fuel flame burner is disposed between the glass bath and the top of the furnace, referred to as the crown. The glass bath is mainly heated by radiation. The exit temperature of the gases is 1300 to 1600° C. depending on the family of glass.

Moreover, manufacturing glass gives off large quantities of gas. The glass bath is degassed for several hours to avoid the formation of bubbles in the glass. To facilitate degassing, refining additives such as sulfates may be used. The furnace operates by batches of glass of selected composition.

The discharge gases, resulting from the degassing and resulting from the combustion, are discharged through a chimney.

The Applicant has pursued the objective of a major reduction in the consumption of energy compared with the mass of glass produced.

In a lime-soda glass, the main initial materials are limestone, soda, for example in the form of sodium carbonate Na₂CO₃, and silica in the form of quartz sand. The limestone and sodium carbonate give off CO₂ during the refining of the glass.

The document JPS55100236 describes the use of slag with a view to manufacturing glass. However, numerous technical obstacles are not dealt with. The Applicant does not have knowledge of an industrial implementation of such a technology.

U.S. Pat. No. 2,084,328 describes a glassworks furnace charge produced from dolomite and kaolin mixed wet. The dolomite and kaolin slip is calcined, and then mixed with soda ash, sand and quicklime.

The document US2005/0022557 described an Na₂CO₃ and SiO₂ premix and in parallel with CaCO₃ and SiO₂ premix with pre-reaction, followed by a mixing of the two premixes and an addition of SiO₂, and then introduction into a glassworks furnace.

The document US2012/0216574 relates to a glass manufacturing method comprising the calcination of CaCO₃ to form CaO, the formation of an Na₂SiO₃ glass in liquid phase, and mixing in liquid phase of the CaO and Na₂SiO₃ to form a lime-soda glass.

Moreover, the Applicant had knowledge of a seminar “Glass Trend Seminar” on 18 and 19 Oct. 2012 at Eindhoven and saw Messrs. Hande Sesigur, Melek Orhon and Banu Arslan from the company SISECAM presenting a document “Alternative Raw Materials for Improving the Melting Properties in Glass Production”, which reports on a trial introducing, into a glassworks furnace, calcined limestone leading to a slight reduction in energy consumption, to easier melting and to an increase in the specific output of the furnace but at a higher cost price per tonne of glass produced, to the high presence of carry-over above the glass bath, to an increased corrosion of the walls of the furnace and to problems of adhesion between particles.

The Application has carried out tests. Replacing the limestone with quicklime in the glass manufacturing materials poses difficulties, in particular relating to the reactivity of the lime with moisture in the air. The economics of lime is less favourable from that of limestone despite a reduced tonnage transported and handled. Moreover, lime with large granulometry is slow to melt in the glassmaking bath and may leave batch stone. A lime with smaller granulometry generates carry-over entrained by the combustion gases. Some of the lime is lost and fouls the smoke pipes downstream of the furnace.

Despite these obstacles, the Applicant has pursued and developed a mixture of glass raw materials. One difficulty appeared during the preparation of the mixture. In the absence of water, the powdery mixture has no strength and generates carry-over in large quantities. However, water and lime react together exothermically. The temperature reached makes the mixture difficult to manipulate.

The Applicant has developed a method for preparing a precursor mixture providing a mixture with low heating and low generation of carry-over, see WO2019/002802. The granulometry of the constituents added to the mixture is substantially preserved except that the mechanical transfer manipulations may generate a grinding effect slightly reducing the granulometry. Said mixture introduced into a glassworks furnace affords a reduction in the energy necessary for producing glass and the quantity of CO₂ given off of the order of 3 to 6%. Moreover, the duration of the melting of the mixture is less than the duration noted during the use of calcium carbonate. The result is an increase in the productivity of the furnace, also resulting in an additional drop in the energy consumption of around 4 to 6%.

The Applicant pursued its research for the purpose of understanding the phenomenon of generation of carry-over. For a high melting kinetics, a fine lime was used commensurate with the availability from lime suppliers. However, in the workshop where the mixtures were prepared in the circuit conveying the prepared composition, the drawback appeared of the dust emitted into the ambient air. A dedusting circuit was installed. However, the dedusting circuit was blocked by a fine lime, that was sticky, and therefore unstable over the duration.

The invention improves the situation.

The invention proposes a method for manufacturing glass comprising preparing a mixture of glass raw materials for a glassworks furnace, wherein water, sand and sodium carbonate are mixed in mass proportions of between 0 and 5%, 40 and 65% and more than 0 and no more than 25% respectively, and secondary glass-making raw materials, and, within a time of less than 10 minutes, preferably simultaneously, calcium oxide and optionally calcium carbonate is added in a mass proportion of between 1 and 20% of the total, the calcium oxide has a granulometry such that more than 97% by mass does not pass through a sieve of 0.125 mm, more than 96% by mass does not pass through a sieve of 0.5 mm, preferably more than 95% by mass does not pass through a sieve of 1 mm.

In one embodiment, the secondary glass-making raw materials comprise at least one from: Al₂O₃, MgO, K₂O, BaO, CeO₂, Er₂O₃, TiO₂, B₂O₃, ZnO, SrO, SnO₂.

In one embodiment, the preparation of the mixture takes place without the addition of heat.

In one embodiment, the raw materials are powdery.

In one embodiment, the granulometry is measured with a sieve with a square mesh.

In one embodiment, said calcium oxide has a d10 granulometry of between 0.5 and 2 mm and d90 of between 3 and 4.5 mm.

In one embodiment, said calcium oxide is formed from grains with a thickness of between 20 and 60% of the length and width.

Screening may be used to measure the granulometry of the elongate grains.

In one embodiment, said calcium oxide is formed from grains with a width of less than 10 mm.

In one embodiment, said calcium oxide is formed from grains with a thickness of less than 3 mm.

In one embodiment, said calcium oxide is formed from grains with a length of less than 15 mm in the case of 90% of the grains.

In one embodiment, said water, sand, calcium oxide and sodium carbonate mixture has a moisture content of no more than 5%.

In one embodiment, the sodium carbonate has a granulometry with less than 5% passing through a sieve of 0.075 mm, less than 15% passing through a sieve of 0.150 mm and less than 5% not passing through a sieve of 0.600 mm.

In one embodiment, said mixture of water, sand and sodium carbonate has a moisture content of no more than 3% with sodium carbonate with a granulometry mainly greater than 0.500 mm and less than 1.000 mm.

In one embodiment, said mixture of water, sand and sodium carbonate has a moisture content of no more than 2% with sodium carbonate with a granulometry mainly less than 0.250 mm.

In one embodiment, said calcium oxide comprises by mass less than 1000 ppm of Fe₂O₃, preferably less than 900 ppm, more preferably less than 850 ppm.

In one embodiment, the initial temperature of the raw materials is at least 30° C. The rate of hydration of the sodium carbonate is increased.

In one embodiment, the calcium oxide has a granulometry such that more than 98% by mass does not pass through a sieve of 0.08 mm.

In one embodiment, the calcium oxide has a granulometry such that more than 97.5% by mass does not pass through a sieve of 0.2 mm.

In one embodiment, the calcium oxide has a granulometry such that more than 97.5% by mass does not pass through a sieve of 0.5 mm.

In one embodiment, the calcium oxide has a granulometry such that more than 98% by mass does not pass through a sieve of 0.125 mm.

In one embodiment, the calcium oxide has a granulometry such that more than 97% by mass does not pass through a sieve of 1 mm.

In one embodiment, the calcium oxide has a d50 granulometry of between 1 and 4 mm, preferably between 1.5 and 4 mm, more preferentially between 2 and 3.25 mm.

In one embodiment, said sand is dry. The quantity of water added is well-controlled. In the variant without addition of water, preferably associated with a medium or large granulometry, the energy consumed is reduced. The sand is considered to be dry at a moisture content of less than 0.1%. The sand may be dried by heating at a temperature of 15 to 20° C. above ambient temperature.

In one embodiment, the water is present in said sand, preferably at 3 to 6% by mass. At least 3% avoids drying of the sand. No more than 4.8% is favourable to slow heating. No more than 6% is favourable to a low emission of dust. The cost of an intentional addition of water is avoided.

In one embodiment, the calcium oxide is devoid of any intentional addition of aluminium oxide. Aluminium oxide can be added during the mixing.

In one embodiment, cullet is added to the mixture of raw materials, before or after the addition of calcium oxide, in a mass proportion of between 5 and 40% of the total. The cullet may come from downgraded batches of glass. The batches are of known composition so that the quantities of other raw materials is adjusted to the quality of glass required.

In one embodiment, the mixture of raw materials is prepared in the solid state. The evaporation of water in the case of a slip is avoided. The consumption of energy of a prior melting of the raw materials is avoided.

In one embodiment, the mixture of raw materials is prepared at a temperature lying between ambient temperature and ambient temperature plus 20° C.

In one embodiment, the mixture of raw materials is prepared at a temperature of between +0 and +35° C. of the prior temperature of the water, of the sand, of the sodium carbonate and of the calcium oxide. A weighted mean can be taken as prior temperature.

In one embodiment, the mixture of raw materials is prepared without addition of thermal energy. Drying of the mixture, which generates fines and therefore carry-over, is avoided.

In one embodiment, the mixture is loaded into an electric furnace.

In one embodiment, a mixture of water, sand, soda and calcium oxide and optionally calcium carbonate is provided in a glassworks furnace, the calcium oxide being in a mass proportion of between 1 and 20% of the total of the mixture, and the mixture is melted by means of at least one flame burner directed towards the mixture. Said burner offers good efficiency and an effect of firing of the carry-over towards the surface of the glass bath in the course of melting or already melted.

In one embodiment, the oxidant supplied to the burner is oxygen.

The effect of firing of the carry-over is increased.

In one embodiment, the water, the sand, the sodium carbonate and the calcium oxide and optionally calcium carbonate are present in mass proportions of between 0 and 5%, 40 and 65%, 1 and 25%, and 1 and 20% respectively for 25% cullet added. The proportion of cullet can vary by adjusting the above proportions.

In one embodiment, the decarbonation of Na₂CO₃ is implemented in a glassworks furnace in liquid phase.

Generally, the mixture of raw materials means glassmaking raw materials.

Other features and advantages of the invention will emerge from the examination of the following detailed description, and from the accompanying drawings, on which:

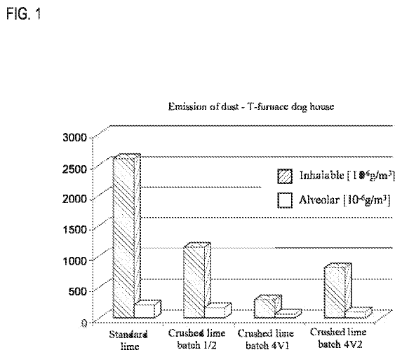

FIG. 1 is a diagram of measurements of ambient air made at the furnace dog house with test batches of quicklime.

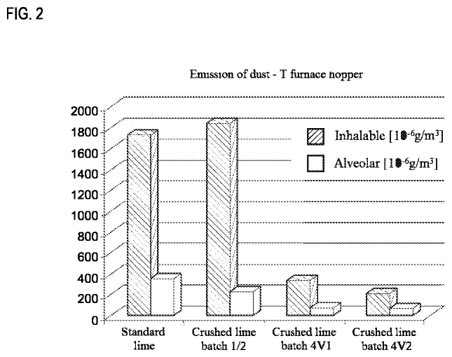

FIG. 2 is a diagram of the measurements of ambient air made under the hopper of the furnace, at the vibrating gangways with test batches of quicklime.

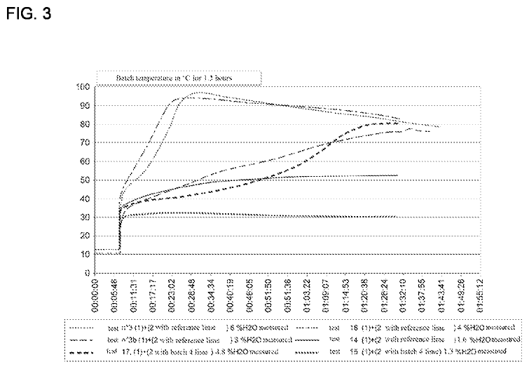

FIG. 3 is a temperature change curve for the vitrifiable mixtures according to the quicklime used and the degree of moisture of the sand.

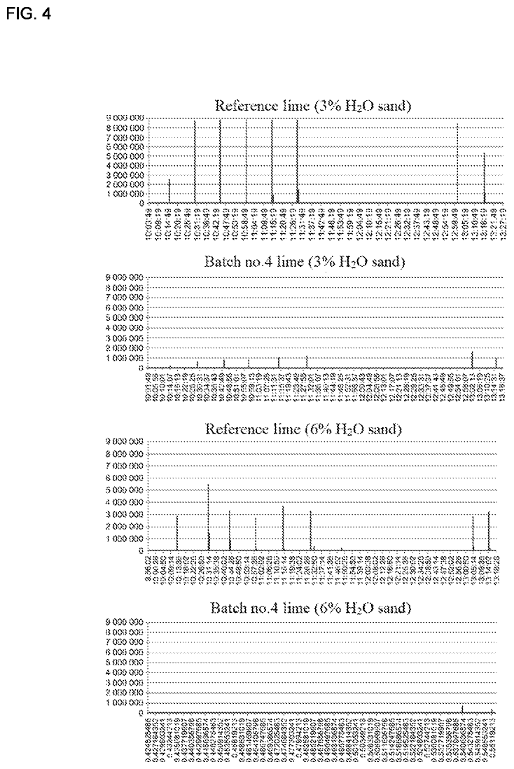

FIG. 4 is a curve for the change in the quantity of carry-over recovered during the laboratory tests according to the quicklime used and the degree of moisture of the sand.

The accompany drawings can serve not only to supplement the invention, but also to contribute to the definition thereof, where applicable.

In addition to the tests reported in WO2019/002802, other tests were conducted.

The majority of the activity subsectors of the glassworks use wet mixtures so as to limit the carry-over of the raw materials, in particular of the sodium carbonate and sand (crystalline silica). The target moisture percentage varies from one installation to another. When moisture is present, the quicklime reacts, which results in a release of heat under the effect of the exothermic hydration reaction, and in an increased generation of dust. Hydrated lime is much more subject to this phenomenon that quicklime or anhydrous lime. This dust is emitted when the mixtures of raw materials are prepared, in the conveying circuits upstream of the furnace, at the time of introduction of the mixture into the furnace, but also in the furnace itself; which in the long term causes an obstruction of the regenerators by depositing on the refractory packing downstream of the furnace.

Moreover, since they are little used in glassmaking, the quicklimes available on the market are unsuitable for the specific requirements of transparent glass:
The chemical characteristics: few limes have an iron content adapted to our requirements, iron being a pollutant of glass degrading the decolourising and transparency of the glass produced.
The granulometry of the quicklime is often very fine (d50 between 0.15 and 0.5 mm) to meet the requirements of existing applications, for example metallurgical, chemical or agricultural.

Through its research programme, the Applicant has managed to use this type of quicklime on its glassworks furnaces.

It has been identified that lime particles of less than 0.100 mm posed a problem. Next it was identified that reducing the proportion of small particles, where applicable by fixing the limit above 0.100 mm, proved to be advantageous for a tangible, stable and reproducible result on the emission of dust. Several batches of quicklime were then tested for us:

2 batches of very different granulometries. Batch no. 1 has a d10 granulometry of less than 0.08 mm, d50 of 0.17 mm, and d90 of 3.18 mm, whereas batch 2 obtained a d10 granulometry of less than 0.08 mm, d50 of more than 2.5 mm and d90 of 3.76 mm. The particles had a form with the three dimensions approximately equal. Batch 2 seemed to be particularly impacted by the presence of very coarse particles, not passing through a sieve of 8 mm, and hence excessively slow melting.

TABLE 1

| Sample sieve diameter | Quicklime batch 1 measurement | |
|---|---|---|
| mm | % retained | % total |
| 4 | 10.3 | 10.3 |
| 3.15 | 4.5 | 14.8 |
| 2 | 6.9 | 21.7 |
| 1 | 9.4 | 31.1 |
| 0.5 | 8.5 | 39.6 |
| 0.2 | 13.5 | 53.1 |
| 0.125 | 26.5 | 79.6 |
| 0.08 | 3.7 | 83.3 |
| Remainder | 16.6 | 99.9 |

TABLE 2

| Sample sieve diameter | Quicklime batch 2 measurement | |
|---|---|---|
| mm | % retained | % total |
| 4 | 34.9 | 34.9 |
| 3.15 | 15.2 | 50.1 |
| 2 | 12.4 | 62.5 |
| 1 | 10 | 72.5 |
| 0.5 | 5.4 | 77.9 |
| 0.2 | 4.6 | 82.5 |
| 0.125 | 2.5 | 85 |
| 0.08 | 2.4 | 87.4 |
| Remainder | 12.5 | 99.9 |

After elimination in the laboratory of the coarsest particles by sieving, the granulometric spectrum of the sieved batch 2, with a d10 granulometry of less than 0.08 mm, d50 of 0.19 mm and d90 of 1.9 mm, is similar to that of batch 1.

TABLE 3

| Sample sieve diameter | Quicklime batch 2 sieve 5 mm measurement | |
|---|---|---|
| mm | % retained | % total |
| 4 | 2.5 | 2.5 |
| 3.15 | 4.3 | 6.8 |
| 2 | 10.8 | 17.6 |
| 1 | 15.4 | 33 |
| 0.5 | 12.4 | 45.4 |
| 0.2 | 14.2 | 59.6 |
| 0.125 | 7 | 66.6 |
| 0.08 | 8.3 | 74.9 |
| remainder | 25 | 99.9 |

A batch no. 3 of grains of quicklime with a granulometry of less than 3.6 mm. The particles had a form with the three dimensions approximately equal. The proportion of fines is similar to that of batch no. 4.

A batch no. 4 of grains of quicklime with a flat shape. In other words, the thickness is around 20 to 60% of the length and width. The width is less than 10 mm. The thickness is less than 3 mm. The length is in general less than 15 mm.

### Industrial Test

To confirm on the production site the impact of these granulometries, tests took place on a production furnace with the batches 1 to 4 presented above.

The quicklime was introduced in accordance with WO2019/002802. The impacts on the emissions of dust into the working environment were measured:

TABLE 4

| | Furnace dog house | | | Vibrating gangways | | |
|---|---|---|---|---|---|---|
| | Inhalable | Thoracic | Alveolar | Inhalable | Thoracic | Alveolar |
| | [10⁻⁶ g/m³] | [10⁻⁶ g/m³] | [10⁻⁶ g/m³] | [10⁻⁶ g/m³] | [10⁻⁶ g/m³] | [10⁻⁶ g/m³] |
| Reference | 2604 | 788 | 217 | 2065 | 1132 | 432 |
| lime | | | | | | |
| Lime batches 1 | 936 | 519 | 154 | 4034 | 1740 | 453 |
| and 2 | | | | | | |
| Lime batch 3 | 825 | 239 | 103 | 208 | 134 | 70 |
| Lime batch 4 | 121 | 68 | 38 | 379 | 174 | 78 |

Batches 1 and 2 do not make it possible to guarantee a substantial improvement in the emissions of dust. If the balance is favourable to the input of materials into the furnace, the emission level at the supply gangways is unchanged or degraded as illustrated above. The fraction of fine particles present was identified as being at the origin of this concern.
Batch 3 has interesting emissions of dust, especially in proximity to the vibrating gangways: between 85 and 95% reduction for inhalable dust, and between 80 and 90% reduction for alveolar dust defined in accordance with the technical aide memoir ED 984 of the INRS, 4^{th} edition, October 2016, ISBN 978-2-7389-2240-3.
Batch 4 has very interesting dust emissions whatever the measurement site: more than 80% reduction for inhalable dust, and more than 80% reduction for alveolar dust defined as above.

In the light of these results, batch 4 was adopted.

Test of longer duration were organised with a granulometry of batch 4 in order also to have a more complete view of the behaviour of this material in the furnace, and to estimate the impact of this novel granulometry on the performances of tonnage produced and of energy consumption observed with its ground fine variant:

Phase 1: introduction in accordance with WO2019/002802.

TABLE 5

| | Quicklime batch 4 | | | |
|---|---|---|---|---|
| Sample | measurement 1 | | measurement 2 | |
| diameter of | | total | | total |
| sieve mm | % retained | % retained | % retained | % retained |
| 4 | 9.4 | 9.4 | 22.3 | 22.3 |
| 3.15 | 23.6 | 33 | 41.6 | 63.9 |
| 2 | 45 | 78 | 31.9 | 95.8 |
| 1 | 19.3 | 97.3 | 2.5 | 98.3 |
| 0.5 | 0.4 | 97.7 | 0.5 | 98.8 |
| 0.2 | 0.2 | 97.9 | 0.2 | 99 |
| 0.125 | 0.2 | 98.1 | 0.1 | 99.1 |
| 0.08 | 0.3 | 98.4 | 0.2 | 99.3 |
| remainder | 1 | 99.4 | 0.2 | 99.5 |

The measurements 1 and 2 were made by sampling in two subdivisions of the same batch of lime that were next mixed and then loaded in the furnace. The proportion of fines of less than 0.20 mm is less than 2.5%. The proportion of fines of less than 0.125 mm is less than 2.0%.

The main teachings of this test were as follows:

Daily tonnage achieved: increase with respect to the same glass obtained from limestone in the absence of quicklime. The daily tonnage performance is preserved compared with a fine lime despite the increase in granulometry.

Energy consumption per tonne of molten glass: absence of increase in furnace consumption related to the increase in the granulometry of the raw material, or even a slight decrease of 3.46% with the quicklime of batch 4.

The tables below compare 4 different periods, using quicklime of the reference batch, of batch 3 and of batch 4. All these production periods are at the same proportion of cullet (25%) and with the same other raw materials: sand, sodium carbonate, etc. During these 4 periods, the daily production was fixed according to the industrial requirements without seeking any particular performance, the normal production of the furnace being 110 tonnes/day in conventional supply with limestone and without quicklime

The reference batch is a quicklime having a d10 granulometry <0.1 mm; d50<0.1 mm; d90<0.92 mm.

TABLE 6
Reference batch

| Day | Tonnage | Energy consumption |
|---|---|---|
| 1 | 127.1 | 100.1% |
| 2 | 127.1 | 100.2% |
| 3 | 127.3 | 101.7% |
| 4 | 128.2 | 99.6% |
| 5 | 128.2 | 98.0% |
| 6 | 126.7 | 99.9% |
| 7 | 132.1 | 100.8% |
| 8 | 134.7 | 99.7% |
| Mean | 128.9 | 100.0% |

The production implemented with the reference lime gave a mean output of 128.9 tonnes per day for 8 days and an energy consumption in methane gas equivalent corrected for temperature and pressure standardised to 100% comparing with the following. The daily values are not very representative because of the high inertia and of the residence times of the materials in the furnace, the averages over 5 days or more give interesting indications.

TABLE 7
Batch 3

| Day | Tonnage | Energy consumption |
|---|---|---|
| 1 | 135.0 | 97.7% |
| 2 | 134.0 | 102.1% |
| 3 | 131.8 | 103.4% |
| 4 | 131.3 | 100.4% |
| 5 | 121.2 | 104.0% |
| 6 | 133.7 | 96.1% |
| Mean | 131.2 | 100.6% |

The production implemented with the lime of batch 3 gave an output of 131.2 tonnes per day over 5 days and an energy consumption per tonne of molten glass of 100.6% with respect to the reference lime. The difference in consumption is not very significant except that the consumption was expected to be very slightly less than 100%. This is because, for identical raw materials, a higher production involves a higher melting kinetics without involving thermal losses of the furnace increasing in the same proportion, and therefore an energy consumption per tonne of molten glass that is lower. Going deeper it will be understood that keeping the furnace at temperature at zero production consumes energy and that, the more the production increases, the more this maintenance energy value is devalued by a greater number of tonnes, giving a total energy consumption per tonne of molten glass that is lower.

TABLE 8
Batch 4

| Day | Tonnage | Energy consumption |
|---|---|---|
| 1 | 116.4 | 99.4% |
| 2 | 120.2 | 104.1% |
| 3 | 128.3 | 97.0% |
| 4 | 128.2 | 103.6% |
| 5 | 125.7 | 100.1% |
| 6 | 127.2 | 99.3% |
| Mean | 124.3 | 100.6% |

The production implemented with the lime of batch 4 during days 1 to 6 gave an output of 124.3 tonnes per day and an energy consumption per tonne of molten glass of 100.6%. Compared with the reference lime, the energy consumption per tonne is very close and the output less than 3.57% whereas the energy consumption per tonne was expected to increase by several points. Compared with batch 3, the energy consumption per tonne is identical and the output drops by 5.53%. For such a drop in output, the energy consumption per tonne was expected to increase significantly.

TABLE 9

| Day | Tonnage | Energy consumption |
|---|---|---|
| 7 | 138.0 | 92.3% |
| 8 | 138.0 | 91.7% |
| 9 | 120.0 | 106.5% |
| 10 | 123.0 | 103.8% |
| 11 | 132.0 | 101.4% |
| 12 | 138.0 | 93.6% |
| 13 | 138.0 | 93.8% |
| 14 | 138.0 | 93.4% |
| 15 | 135.0 | 93.5% |
| 16 | 125.0 | 99.1% |
| 17 | 125.0 | 99.8% |
| 18 | 125.0 | 97.7% |
| Mean | 131.3 | 97.2% |

The production made with the lime of batch 4 during days 7 to 18 gave an output of 131.3 tonnes per day and an energy consumption per tonne of molten glass of 97.2%. Compared with the reference lime, the energy consumption per tonne drops by 2.8% and the output is greater by 1.86%.

Compared with batch 3, the output is substantially identical and the energy consumption per tonne drops by 3.40 percentage points. Such a drop in energy consumption per tonne is unexpected.

From another point of view, taking the hypothesis that the energy consumption per tonne changes linearly with the output, an output of 128.9 tonnes would correspond an energy consumption per tonne of 98.4%, i.e. a drop of 1.60 percentage points. However, it is generally considered in glassmaking that a coarse raw material takes longer to melt than a fine raw material and therefore requires higher energy per tonne of molten glass. This unexpected behaviour is illustrated by batch 3 for which, for an increasing output of 1.78%, sees an energy consumption per tonne increasing by 0.6%. The same behaviour was expected for batch 4. However, the energy consumption per tonne of batch 4 drops by 3.40 percentage points compared with batch 3. This difference is considerable and difficult to explain. One hypothesis would be a better transmission of the heat within the raw materials related to the flattened form of the lime grains.

The temperature of the composition in the composition day hopper is less high with batch 4 than with the reference batch. The temperature is of the order of 37/38° C. The emissions of dust in the ambient air decrease appreciably. The emissions of dust in the furnace are evaluated by a measurement over 24 hours by means of a cooled paddle placed at the top of the regenerators.

On average, during this test with quicklime of batch 4, 84 mg of dust per tonne of molten glass was harvested on this paddle, as against an average of quicklime of the reference batch of 100 mg/tonne of molten glass. Moreover, the chemical analysis of the harvested dust shows a drop of 50% of their CaO content, proof that this difference in carry-over does indeed result from a change in behaviour of the quicklime in the furnace.

Then an industrial test A was prepared. Identical mixtures were prepared with the quicklime of batch no. 4. This time, the quicklime was introduced directly into the mixers, without complying with the introduction delay stipulated by WO2019/002802 and delivered to the same furnace. The temperature of the composition was measured at 22° C. at the mixers, 25° C. in the delivery lorry at the start of the work site, and at 27° C. in the furnace hopper receiving the lorries. There was no appreciable emission of dust when the lorry was emptied into the hopper. These mixtures were introduced into the furnace, with a composition temperature measured at 37° C., without causing any concerns in the furnace. The test corresponds to approximately 2 hours of operation of the furnace.

During a test B, approximately 30 hours of feeding the furnace were implemented continuously at iso-composition. The mixtures were prepared with quicklime of batch no. 4, without any waiting time for putting the quicklime in contact with the rest of the moist raw materials. This long-duration test made it possible to confirm the good conditions of handling of the mixtures both at the composition work site and on the production sector (no emissions of dust along the conveyors, elevators, vibrating gangways, furnace dog house, etc.) and the absence of any rise in temperature noted, neither at the composition work site nor on the furnace, whether the measurement was made in the hopper receiving the charges with measured temperatures ranging from 25 to 31° C., in the day hopper with measured temperatures ranging from 30 to 45° C. This observation is valid whatever the moisture level sought in the composition: 1.4% at the start of the test, 2.5% on the last 3 charges.

The continuous recording of the temperature of the composition at the hopper immediately upstream from the furnace shows in parallel an increased stability of this parameter compared with operation with quicklime of the reference batch.

No anomaly in the operation of the furnace was noted during this test.

To supplement these industrial tests, experiments were implemented in the laboratory to confirm the behaviour of this quicklime of batch no. 4.

These studies were implemented by preparing, in a test mixer (concrete mixer) a vitrifiable mixture of lime-soda glass according to the following operating method:
Moistening of a dry sand to the required moisture level by adding water, and mixing for 180 s.
Simultaneous addition of sodium carbonate, alumina, dolomite and quicklime to the moistened sand, and mixing for 120 s, with the lid on the concrete mixer.

All the materials were weighed so as to reproduce, on a reduced scale, a standard lime-soda mixture of the Applicant.

Two distinct and complementary approaches were implemented:
Study of the reaction between quicklime and moist raw materials: the temperature of the vitrifiable mixture after preparation thereof was recorded by inserting a thermocouple at the core of the material. The starting temperatures are the same for all the tests. For low moisture level of the sand of 1.3% and the lime of batch no. 4, no reaction is to be noted (curve in fine broken line reference “test 15” in FIG. 3), which confirms the industrial tests. This result is to be compared with the curve of the reference lime at 1.6% moisture of the sand (curve in light continuous line referenced “test 14”), which reaches 40° C. in approximately 5 to 6 minutes. By aiming at a higher moisture level of the sand at 4.8%′ and the lime of batch no. 4, an exothermic reaction is established (curve in long-dashed line reference “test 17”) in FIG. 3, reaching 40° C. in approximately 10 minutes. This increase is appreciably slower than for the quicklime of reference batch at 4% (curve in mixed dashes referenced “test 16”) and 6% (curve in thick broken line reference “test 3”) of moisture level of sand. These two tests on reference lime at 4% and 6% moisture of the sand show a strong and rapid increase in the temperature in a few seconds. The test at 3% (curve in short dashes referenced “test 3b”) of moisture of the sand and the reference lime has an intermediate behaviour but with a temperature higher than that of test 17 between 10 and 60 minutes after the mixing. In other words, the temperatures of 40, 50 and 60° C. are reached more quickly with test 3b than with test 17. The test on the lime of batch no. 4 with a moisture level ranging up to at least 4.8% is adapted to industrial tools.

Measurements of fly ash−/− emissions of dust: according to the same operating method, mixtures were prepared. The emissions of dust coming from the concrete mixer were measured, by regularly (every 15 minutes) rotating the latter in order to simulate a manipulation of the composition (conveying, passage into a vibrating gangway, etc.). This measurement was made by means of a dust-measuring apparatus, and over a total period of approximately 3.5 hours; a period making it possible to take into consideration a momentary storage of the composition in the storage members before feeding the furnace.

A comparison of the readings made between quicklime of the reference batch and quicklime of batch 4 shows a very appreciable improvement by using the quicklime of batch 4: a saving of up at least 50%, or even 90%, on the emissions of the dust (the graphs in FIG. 4 are to the same scale; the reduction in the amplitude of the peaks indicating a lesser emission of dust) whatever the percentage of water in the sand, for values of 3 and 6%. Thus a percentage of water in the sand of between 2 and at least 7% is envisaged.

Quicklime with a low level of fines therefore affords advantages for the preparation and the manipulation of vitrifiable mixtures by considerably reducing the emissions of dust in the ambient air. Its high granulometry makes it possible to limit the exothermic hydration reaction because of the smaller exposed surface. Unexpectedly, the layer of hydrated lime created on the surface of the quicklime grains by contact with the water present in the other materials, in particular the sand, does not appear to participate in the fly ash in the feed and storage members situated upstream of the furnace. Because of this, such a raw material can be used without complying with a waiting time for putting the quicklime in contact with the rest of the raw materials.

1. A method for manufacturing glass, comprising preparing a mixture of raw materials of glass for a glassworks furnace,
wherein water, sand and sodium carbonate are mixed in mass proportions of between 0 and 5%, 40 and 65%, and more than 0 and no more than 25% respectively, and secondary glassmaking raw materials,
wherein, within a time of less than 10 minutes, calcium oxide is added, in a mass proportion of between 1 and 20% of the mixture, and
wherein the calcium oxide has a granulometry such that more than 97% by mass does not pass through a sieve of 0.125 mm, and more than 96% by mass does not pass through a sieve of 0.5 mm.

2. The method according to claim 1, wherein said calcium oxide is formed by grains with a thickness of between 20 and 60% of a length and width, the thickness being less than 3 mm.

3. The method according to claim 1, wherein said mixture of water, sand, calcium oxide and sodium carbonate has a moisture level of no more than 5%.

4. The method according to claim 1, wherein the sodium carbonate has a granulometry with less than 5% passing through a sieve of 0.075 mm, less than 15% passing through a sieve of 0.150 mm and less than 5% not passing through a sieve of 0.600 mm.

5. The method according to claim 1, wherein said calcium oxide comprises by mass less than 1000 ppm of Fe₂O₃.

6. The method according to claim 1, wherein an initial temperature of the raw materials is at least 30° C.

7. The method according to claim 1, wherein the calcium oxide has a granulometry such that more than 98% by mass does not pass through a sieve of 0.08 mm.

8. The method according to claim 1, wherein the calcium oxide has a granulometry such that more than 98% by mass does not pass through a sieve of 0.125 mm.

9. The method according to claim 1, wherein the calcium oxide has a d50 granulometry of between 1 and 4 mm.

10. The method according to claim 1, wherein said sand is dry.

11. The method according to claim 1, wherein the water is present in said sand.

12. The method according to claim 1, wherein the calcium oxide is devoid of any intentional addition of aluminium oxide, and cullet is added to the mixture of glass raw materials, in a mass proportion of between 5 and 40% of the mixture.

13. The method according to claim 1, wherein the mixture of glass raw materials is prepared in the solid state.

14. The method according to claim 1, wherein the mixture of glass raw materials is prepared at a temperature of between ambient temperature and ambient temperature plus 20° C., and the mixture of glass raw materials is prepared without addition of thermal energy.

15. The method according to claim 1, wherein said mixture is loaded into an electric furnace.

16. The method according to claim 1, wherein an oxidant supplied to a burner is oxygen.

17. The method according claim 15, wherein the water, sand, sodium carbonate and calcium oxide are present in mass proportions of between 0 and 5, 40 and 65, 1 and 25, and 20% respectively.

18. The method according to claim 1, wherein, within the time of less than 10 minutes, calcium carbonate is added in a mass proportion of between 1 and 20% of the mixture.

19. The method according to claim 18, wherein the calcium oxide and the calcium carbonate are added simultaneously.

20. The method according to claim 1, wherein more than 95% by mass does not pass through a sieve of 1 mm.
